(19) United States
(12) Patent Application Publication
(10) Pub. No.: US 2012/0253931 A1
(43) Pub. Date: Oct. 4, 2012

(54) SYSTEM AND METHOD FOR IMPLEMENTING MEMBERSHIP PROGRAM

(75) Inventors: Timothy J. Connolly, Houston, TX (US); E. Sean Connolly, Houston, TX (US); Robert Zayas, Houston, TX (US)

(73) Assignee: VIP MEMBERS CORP., Houston, TX (US)

(21) Appl. No.: 13/425,961

(22) Filed: Mar. 21, 2012

Related U.S. Application Data
(60) Provisional application No. 61/499,399, filed on Jun. 21, 2011.
(60) Provisional application No. 61/470,468, filed on Mar. 31, 2011.

(51) Int. Cl. G06Q 30/02

(52) U.S. Cl. 705/14.53; 705/14.56

(57) ABSTRACT

A method of implementing a product and/or service promotion membership program, comprising the steps of: enrolling at least one business to participate in the membership program; obtaining personal information from a consumer; contacting the consumer to: obtain confirmation that the consumer desires to participate in the membership program; and obtain information about the consumer's interest in products or services provided by the participating business; and periodically providing information to the consumer concerning a promotion available to the consumer at the participating business.

### CROSS REFERENCE TO RELATED APPLICATIONS:

This application is a non-provisional application, and claims priority benefit, of U.S. Provisional Patent Application Ser. No. 61/470,468, filed Mar. 31, 2011. This application is also a non-provisional application, and claims priority benefit, of U.S. Provisional Patent Application Ser. No. 61/499,399, filed Jun. 21, 2011. Both of these applications are incorporated herein by specific reference.

### STATEMENT REGARDING FEDERALLY SPONSORED RESEARCH

Not applicable.

### REFERENCE TO APPENDIX

Not applicable.

### BACKGROUND OF THE INVENTION

1. Field of the Invention

This disclosure relates generally to methods and systems for implementing product and/or service promotion membership programs. More particularly, the disclosure relates generally to methods and systems for implementing a membership program that does not require a consumer to pay a membership fee, use a membership card, or purchase coupons to take advantage of discounts, promotional offers, or other membership benefits from merchants.

2. Description of the Related Art

Various types of product and/or service promotion membership programs have existed in the art. These programs typically provide discounts and promotional offers to their consumer members as a way to enhance revenues for their merchant members. The discounts and promotions encourage the consumer members to frequent the businesses of the merchant members where they will presumably purchase products and/or services from the merchant members. However, existing membership programs typically require the consumer members to pay an annual membership fee and/or use a membership card to take advantage of membership benefits. Other similar programs currently in use require the consumer to purchase a coupon to take advantage of promotions. These arrangements are undesirable, though, because of the coupon required and the need for the consumer to pay a fee to take advantage of the promotion. Additionally, such coupons typically have an expiration date and in some instances the consumer simply forgets to use the coupon.

### SUMMARY OF THE INVENTION

The disclosed embodiments overcome the disadvantages of the prior art through a membership program that includes:
a. enrolling at least one business to participate in the membership program;
b. obtaining some personal information from a consumer who visits a business participating in the membership program;
c. contacting the consumer to:
   i. obtain confirmation that the consumer desires to participate in the membership program; and
   ii. obtain information about the consumer's interest in products or services provided by the participating business; and
d. periodically providing information to the consumer concerning a promotion available to the consumer at the participating business.

An important, but not required, aspect of the disclosed embodiments is that the consumer is not required to purchase a coupon to take advantage of a promotion at the participating business. Another important, but not required, aspect of the disclosed embodiments is that the consumer is not required to use a membership card.

Yet another aspect of the disclosed embodiments is that the promotion information is provided to the consumer via the consumer's remote device. Still another aspect of the disclosed embodiments is that the consumer takes advantage of the promotion at the business by showing the promotion information on his or her remote device.

Yet another aspect of the disclosed embodiments is that the personal information obtained in step b above is the consumer's phone number. Still another aspect of the disclosed embodiments is that as a part of step c above, personal information about the consumer is obtained, including the consumer's name. In some embodiments, as a further part of step c, the name of the consumer's significant other is obtained.

A further important, but not required, aspect of the disclosed embodiments is that when step d is performed, the information is personalized, for example, by using the consumer's name. A yet further aspect of the disclosed embodiments is that when step d is performed, the information may be personalized by using the significant other's name.

The disclosed embodiments also overcome the disadvantages of the prior art through a membership program that includes:
a. enrolling at least one business to participate in the membership program;
b. obtaining some personal information from a consumer who visits a business participating in the membership program;
c. contacting the consumer via a remote device belonging to the consumer to:
   i. obtain confirmation that the consumer desires to participate in the membership program; and
   ii. obtain information about the consumer's interest in products or services provided by the participating business;
d. periodically providing information to the consumer concerning a promotion available to the consumer at the participating business; and
e. not requiring the consumer to purchase coupons in order to take advantage of the available promotion.

In another aspect of the disclosed membership program, a determination may be made as to whether the consumer takes advantage of the available promotion. This information may be important feedback to the business in order evaluate the effectiveness of the membership program and/or to promote the effectiveness of the membership program to other businesses.

### BRIEF DESCRIPTION OF THE DRAWINGS

The foregoing and other advantages of the disclosed embodiments will become apparent from the following detailed description and upon reference to the drawings, wherein:

FIG. 1 illustrates an exemplary flow chart showing a merchant-solicited member sign-up aspect of the disclosed membership program.

FIG. 2 illustrates an exemplary flow chart showing a member sign-up aspect of the disclosed membership program.

FIG. 3 illustrates an exemplary flow chart showing a merchant sign-up aspect of the disclosed membership program.

FIG. 4 illustrates an exemplary system that may be used to implement the disclosed membership program.

FIG. 5 illustrates an exemplary server that may be used to implement the disclosed membership program.

### DETAILED DESCRIPTION

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the disclosed embodiments will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the invention or the appended claims.

As mentioned above, the disclosed embodiments relate to a product and/or service promotion membership program. The membership program is preferably a Web-based VIP membership program that is operable by administrators and accessible by users via a Web site. In one embodiment, the disclosed VIP membership program has restaurants and bars and the customers thereof as an industry focus. However, those having ordinary skill in the art will understand that the principles and concepts disclosed herein are equally applicable to membership programs focusing on other industries, including the hotel industry, travel industry, gaming industry, and the like.

In the exemplary Web-based VIP membership program, all the standard functionality of registration, user name and password, and the like, is available for each member. Communication of promotional events, discounts, and other information in such a Web-based VIP membership program may be conducted electronically, for example, by text messages, emails, Twitter feeds, and the like. The effectiveness and potential success of such a membership program is generally defined around the size, demographics, and quality of the members and merchants databases. To this end, sign-up for VIP membership should be easy, risk free, and require a minimum amount of personal information. The VIP members may join the membership program through their own accord, but preferably the VIP merchants identify and solicit specific customers for sign-up based on, for example, the amounts spent by the customers, frequency of their visits, and other similar criteria. From the viewpoint of the VIP merchants, the process of signing up members should be easy for waitpersons and other personnel to perform, and should not interrupt the flow of the restaurant's or bar's (or other businesses') basic service model. Additionally, for VIP merchants, the process of communicating promotions to VIP members should be automatic and easily managed from the perspective of tracking the discounts offered. Following is a description of one possible implementation of the disclosed VIP membership program.

In general, customers may be solicited by any restaurant or other VIP merchant that is a member of the VIP membership program to join the VIP membership program. The customers may be informed that they may join simply by sending an electronic message (e.g., text, email, etc.) to the restaurant's VIP membership account (e.g., VIP PFChangs). The customers may thereafter receive a confirmation message in which they may be asked to immediately reply and confirm. Doing so completes the registration process and the customers are now VIP members.

A similar process may be employed for other businesses, such as various types of hotels, casinos, resort and vacation condominiums, including timeshares, and the like. For example, when customers check in to a hotel that is a VIP merchant, the hotel clerk, receptionist, concierge, or other hotel personnel may invite the customers to join the VIP membership program. The customers may be invited, for example, to send a text, email, or other electronic message to the hotel's VIP membership account (e.g., VIP Marriott). The customers may then receive a confirmation message in which they may be asked to reply to confirm, typically with their first name, and sometimes also their ZIP code, that they have elected to join the VIP membership program.

In the above restaurant, bar, hotel, casino, resort, and other embodiments, once the customers have indicated their consent or otherwise agreed to join the VIP membership program, it is also possible for the VIP merchant employee to immediately initiate the VIP membership sign-up process for the customers. For example, the VIP merchant employee may initiate the process for the customers by sending them a text, email, or other electronic invitation message from the restaurant or hotel VIP membership account (assuming the VIP merchant has or can obtain the customers' electronic messaging information). The electronic invitation message may request that the customers reply to the message to join the VIP membership program and, in a typical embodiment, may ask the customers to include their first name and possibly their ZIP code too in the reply. In any case, this approach helps further simplify the sign-up process for the customers in that they need simply reply to the electronic invitation message to join the VIP membership program. VIP merchants may also benefit from this approach insofar as it allows them to proactively initiate the sign-up process for their customers rather than waiting for the customers to start the process. Both parties may benefit from this approach as the VIP membership account may be automatically populated with the customers', or VIP members', information already contained in the VIP merchants' system(s).

Customers may also join via the VIP membership program Web site. As part of that process, these customers may be asked several preferably “yes”/“no” questions to qualify as a member. Answering “yes” to a minimum number of these questions (e.g., 50%) may qualify them as a member, and they may receive a notice within a predefined period (e.g., 24 hours) that they have been accepted as members. These new members may also be asked to refer their friends, co-workers, relatives, and the like, to become members of the VIP membership program. The referral may be accomplished using a Web form that asks the member to provide, for example, the email addresses of such friends, co-workers, relatives, and the like. In one embodiment, the qualification process, the “yes”/“no” questions to qualify, is only used when a potential member comes to the Web site on their own. However, in other embodiments, the qualification process may be used for referrals as well. Of course, in the preferred embodiment, VIP members referred by VIP Merchants are preferably automatically enrolled.

The new member confirmation message may include a thank-you along with a request that the new member reply with their first name and, in some cases, their zip code as well. The message may also include a link to a preference page asking them to provide certain personal information, such as gender, favorite entrées, appetizers, drinks, desserts, name of significant others, zip code, and/or email address. This preference information may be used to populate periodic (e.g., weekly, bi-weekly, etc.) and possibly occasion-specific (e.g., holidays, birthdays, etc.) offers to the members via text message, email, Twitter feed, and the like. In the event the member procrastinates or forgets to fill out the preference page, their first name and zip code may be used to design promotion offers for that member until such time when the member can complete the preference page.

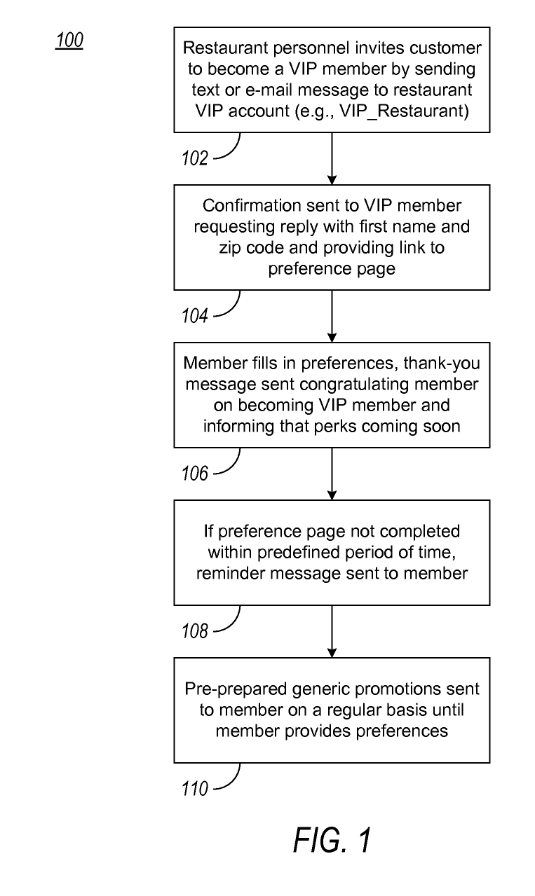

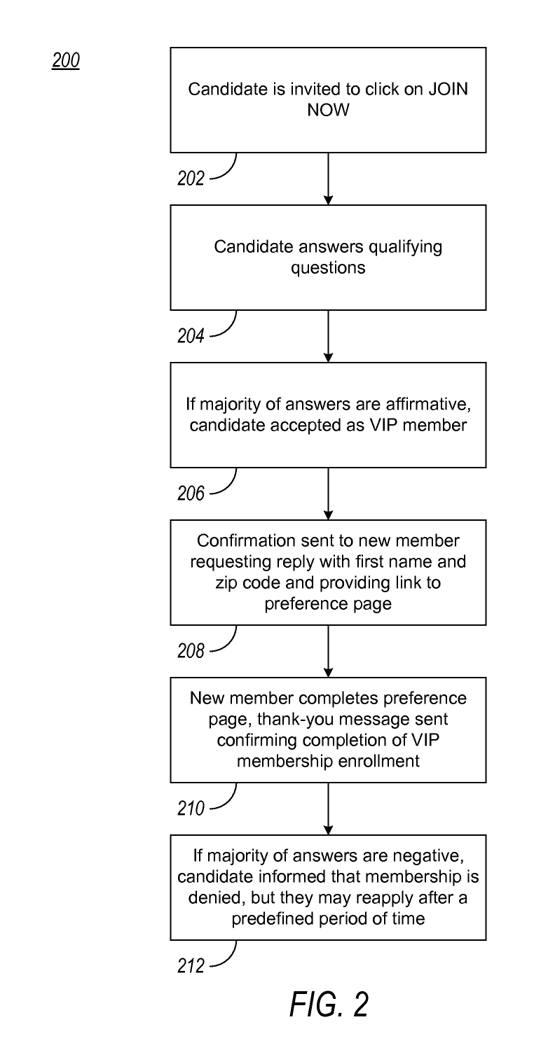

FIGS. 1 and 2 show flowcharts illustrating examples of the disclosed membership sign-up processes. As can be seen in FIG. 1, a merchant-solicited member enrollment process 100 may begin at block 102, where restaurant personnel invite customers to become a VIP member by having the customers send a text or email message to the restaurant VIP account (e.g., VIP Restaurant). At block 104, a confirmation message is sent requesting that the customer reply with their first name and zip code and containing a link to a registration and preference page. Alternatively, as mentioned above, once a customer has indicated their consent to become a VIP member, the restaurant personnel may promptly initiate the sign-up process for the customers by sending them a text or email message requesting that they reply with their first name and zip code, and containing a link to the registration and preference page. At block 106, the customers clicks on the link, goes to the preference page, and fills in the their preferences, after which a thank-you message is sent congratulating the customers on becoming a VIP member and informing them that perks are coming soon. The preference information may then be used to customize promotional offers and VIP perks for the new member, to be sent by text or email message on a regular basis (e.g., once or twice per week) to the new member. At block 108, if the customers do not complete their preferences within a predefined period of time, reminder messages may be sent inviting them to complete the preferences. Pre-prepared generic promotion messages may be sent to the member on a regular basis (e.g., weekly) until such time when the member provides their preferences. Examples of such generic promotion messages may include “one free entree with a paid entrée of equal or greater price,” or “25% off on your entire meal,” or “free appetizer with your paid entrée,” or “free dessert with your paid entrée,” and the like. VIP merchants may be selected automatically for the member from a list of available VIP merchants based on the member's zip code (e.g., merchants within 5 miles of the zip code) for purposes of the generic promotion messages.

FIG. 2 shows a flowchart illustrating a sign-up process 200 that consumers may initiate of their own accord by visiting the VIP membership program Web page. At block 202, the member candidate is invited to click on a link, such as JOIN NOW, to become a VIP member. The candidate is then asked a number of qualifying questions at block 204. At block 206, if a majority of the answers are affirmative, the candidate is accepted as a VIP member. At block 210, a confirmation message is sent to the new member requesting that they reply with their first name and zip code and providing a link to a preference page. At block 212, the new member completes the preference page and a thank-you message is sent confirming that the member has completed the VIP membership enrollment process. Until the member completes the preference page, however, only predefined generic promotions will be sent to the member, with VIP merchants automatically selected for the member based on their zip code. At block 208, if the majority of the answers are negative, the candidate is informed that their membership is denied, but that they may reapply after some predefined period of time.

Once the membership enrollment process is completed, predefined promotional and/or discount offers may be developed for each VIP member such that the VIP merchants do not have to direct, manage, or deal with the creation of the offers in any fashion. The VIP merchant need only approve the offers, give the VIP members priority seating at all times, and on a periodic basis (e.g., monthly), provide the VIP members at least one free item, such as a free entrée with a purchased entrée, a free drink with dinner, a free dessert, a free appetizer, a 10 percent discount on an entire meal, or a 25 percent discount on all food items. These offers are preferably standardized each week (or some other interval) so the merchant's personnel may be easily informed (e.g., the VIP offer of the week is a free drink with dinner, etc.). The VIP member may then present their virtual VIP membership ID, for example, via their smart phones or other mobile devices, and be eligible to receive that week's promotion or discount.

In most embodiments, there is no membership fee for VIP members. However, the VIP membership program may charge VIP merchants a fee on a yearly, quarterly, or monthly basis. In addition, or alternatively, individual VIP merchants may be charged on a per message basis for the promotional offers sent to VIP members on each merchant's behalf. It is also possible to implement a combination of the two models, for example, the first 1000 offer messages may be free each quarter, but all subsequent messages may be charged on a per message basis. The VIP membership Web site may be set up to provide a reporting page for each merchant showing certain information about their account, such as how many VIP members they have, how many messages have been sent month to date, the number of free messages remaining, and the like.

One or more databases may be used to store and track information concerning the VIP members and merchants, including preference information for the VIP members. The database for the VIP members in particular may be searchable, such as by zip code, area code, and the like. This allows a VIP membership application to run customized campaigns for VIP merchants by specifically targeting their neighborhoods with special offers to members in their areas, potentially resulting in additional revenue for the merchants (as well as the VIP membership program).

VIP members may be encouraged to recommend/nominate both new members and merchants, for example, by hosting contests and awarding points for each new member recommended. New VIP members nominated may earn the referring member a predefined number of points (e.g., 1000 points), and newly-referred VIP merchants may earn the referring member another predefined number of points (e.g., 10,000 points). VIP members may also earn Gold, Platinum, or Diamond status each year, and may further qualify for gifts, trips, premiums from a catalogue in exchange for these points each year.

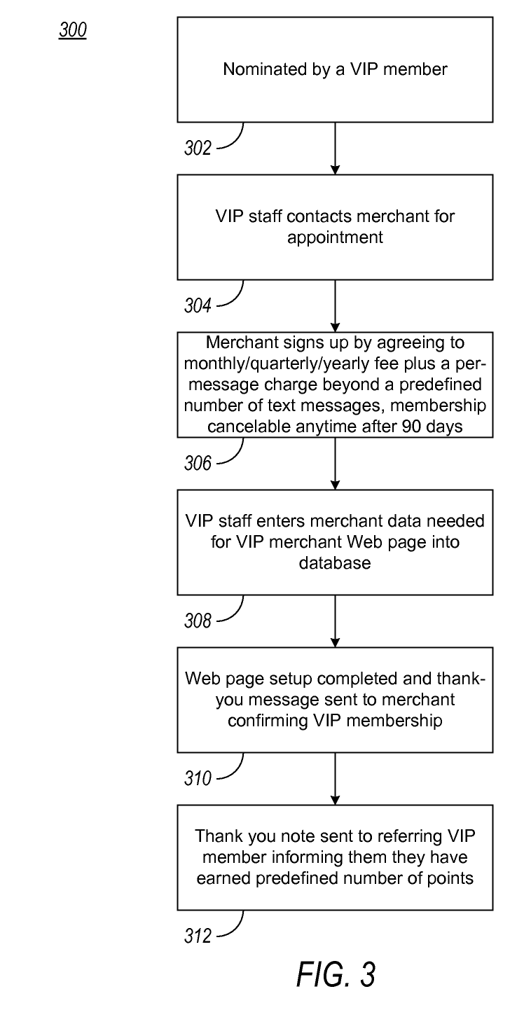

The VIP membership program preferably provides each VIP merchant with a template mobile site as their Web page on the VIP membership Web site. This Web page may feature the merchant's look-and-feel, include photos of their restaurant that can be rotated on their page, and may include information such as address/directions, menu, prices, and the like. VIP members may also be able to place “to go” orders and pay for them in advance on these Web pages. The VIP membership program may then process the payment of these orders, thereby generating additional revenue in the form of payment processing fees for the program. Savings may also accrue for the merchants. In one example, if the merchants do at least $1 million or more in processing of credit cards each year through the program, they may realize a savings of up to half of 1% of their costs of processing. An example of a process that may be used to enroll a member-nominated merchant is illustrated in FIG. 3.

As can be seen in FIG. 3, a flowchart depicting a member-nominated merchant enrollment process 300 begins at block 302, where a member nominates a merchant to join the VIP membership program by submitting the merchant's name via the program Web site or sending a message to program administrative personnel. At block 304, program personnel contacts the merchant for an appointment to discuss becoming a VIP merchant. At block 306, the merchant signs up to become a VIP merchant by agreeing to the membership fee and other program charges. In one example, the merchant may be charged $297 per quarter for a predefined number of text messages sent by the program to VIP members on the merchant's behalf, plus $0.30 per text message thereafter. At block 308, program personnel enters the merchant's data needed for setting up the merchant's Web page on the VIP membership Web site into the program database. At block 310, setup of the Web page for the merchant is completed, and a thank-you message is sent confirming the merchant's VIP membership. At block 312, a thank-you message is also sent to the referring VIP member informing them that they have received a certain number of points (e.g., 30,000 points) for the successful referral.

A homepage may also be provided for VIP members. The VIP member homepage may provide links to the various VIP merchants and may offer the members certain perks, such as free drinks, and the like. These perks may be in a particular format, such as a “Perk of the Day,” “Perk of the Week,” “Perk of the Month,” and so forth. The membership program may charge the VIP merchants an additional fee for hosting the perk of the day, and may charge an extra fee, such as a per-click fee, for displaying additional VIP member perks on the VIP member homepage.

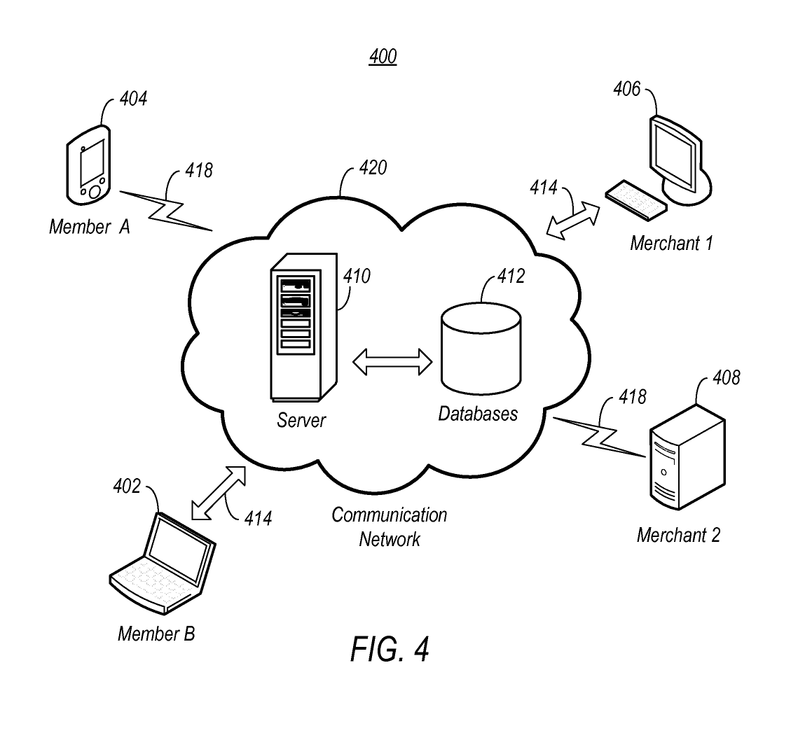

Turning now to FIG. 4, an exemplary system 400 is shown that may be used to implement the VIP membership program disclosed herein. As can be seen, the system 400 includes a plurality of computing devices 402, 404, 406, and 408 connected to a communication network 420 having at least one Web server 410 and one or more databases 412 connected thereto. In the example shown, the computing devices 402 and 404 are typically mobile devices, such as smart phones, tablets, laptops, and the like that are commonly used by members, such as Members A and B. The computing devices 406 and 408, on the other hand, are more typically traditional computing devices, such as desktops and personal computers commonly used by merchants, such as Merchants 1 and 2, although these devices may also be mobile devices. These computing devices 402, 404, 406, and 408 may connect to the communication network 420 using any suitable network connections, including broadband connections 414, wireless connections 418, and the like.

Referring still to FIG. 4, the communication network 420 may be a private network such as a corporate intranet, or it may be a public network such as the Internet. The at least one Web server 410 and the one or more databases 412 that are connected to the communication network 420 may reside in the same physical location or in physically separate locations, depending on the constraints (e.g., size, speed, etc.) of the particular implementation. In the present example, the at least one Web server 410 may be a server that is capable of hosting a Web-based application over the communication network 420, and the one or more databases 412 may be relational databases, operational databases, or other suitable databases capable of storing data for the Web-based application. The Web-based application, in accordance with the disclosed embodiments, is a VIP membership application that is capable of implementing a VIP membership program as described above.

In general operation, each of the VIP members and VIP merchants may access the Web site hosted on the at least one Web server 410 via the communication network 420 using one of the computing devices 402, 404, 406, and 408 by sending an electronic message to the address of the at least one Web server 410 or by entering the URL of the Web server 410 into a Web browser. Any data and information collected about the VIP members and VIP merchants may be stored and maintained in the one or more databases 412.

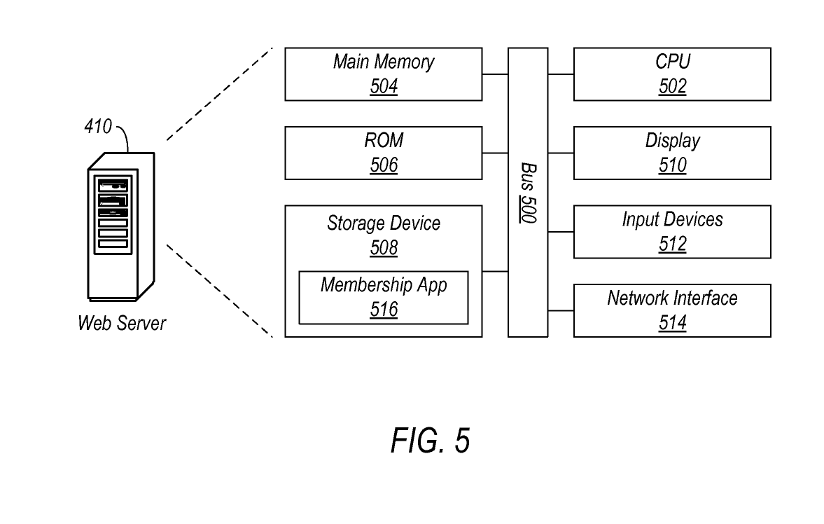

FIG. 5 illustrates an exemplary Web server that may be used as one of the at least one Web server 410 on the communication network 420. This Web server 410 may be any suitable computing system known to those having ordinary skill in the art, including a high-end personal computer, workstation, main frame, and the like, running Windows Server, Mac OS X Server, Linux, FreeBSD, Solaris, Unix, z/OS, and the like.

Such a Web server 410 typically includes a bus 500 or other communication mechanism for transferring information within the Web server 410 and a CPU 502 coupled with the bus 500 for processing the information. The Web server 410 may also include a main memory 504, such as a random access memory (RAM) or other dynamic storage device coupled to the bus 500 for storing computer-readable instructions to be executed by the CPU 502. The main memory 504 may also be used for storing temporary variables or other intermediate information during execution of the instructions to be executed by the CPU 502. The Web server 410 may further include a read only memory (ROM) 506 or other static storage device coupled to the bus 500 for storing static information and instructions for the CPU 502. A computer-readable storage device 508, such as a magnetic disk or optical disk, may be coupled to the bus 500 for storing information and instructions for the CPU 502.

The term “computer-readable instructions” as used above refers to any instructions that may be performed by the CPU 502 and/or other components of the Web server 410. Similarly, the term “computer-readable medium” refers to any non-transitory storage medium that may be used to store the computer-readable instructions. Such a computer-readable medium may take many forms, including, but not limited to, non-volatile media, volatile media, and transmission media, but generally does not include transitory medium (e.g., electrical or optical signals, etc.). Non-volatile media may include, for example, optical or magnetic disks, such as the storage device 508. Volatile media may include dynamic memory, such as main memory 504. Transmission media may include coaxial cables, copper wire and fiber optics, including wires of the bus 500. Transmission itself may take the form of acoustic or light waves, such as those generated during radio frequency (RF) and infrared (IR) data communications. Common forms of computer-readable media may include, for example, a floppy disk, a flexible disk, hard disk, magnetic tape, other magnetic medium, a CD ROM, DVD, other optical medium, a RAM, a PROM, an EPROM, a FLASH EPROM, other memory chip or cartridge, or any other tangible medium from which a computer can read.

The CPU 502 may also be coupled via the bus 500 to a display 510, such as a liquid crystal display (LCD), cathode ray tube (CRT), and the like for displaying information to a user. One or more input devices 512, including alphanumeric and other keyboards, mouse, trackball, cursor direction keys, and so forth, may be coupled to the bus 500 for communicating information and command selections to the CPU 502. A network interface 514 provides two-way data communication between the Web server 410 and other computers over the communication network 408. In one example, the network interface 514 may be an integrated services digital network (ISDN) card or a modem used to provide a data communication connection to a corresponding type of communication line. As another example, the network interface 514 may be a local area network (LAN) card used to provide a data communication connection to a compatible LAN. Wireless links may also be implemented via the network interface 514. In summary, the main function of the network interface 514 is to send and receive electrical, electromagnetic, optical, or other signals that carry digital data streams representing various types of information.

In accordance with the disclosed embodiments, the computer-readable storage device 508 may store thereon computer-readable instructions representing a VIP membership application 516. The computer-readable instructions making up the VIP membership application 516 may then be executed by the CPU 502 and other components of the Web server 410 to implement a VIP membership program as disclosed and described herein. Such a VIP membership application 516 may be written in any suitable computer programming language known to those of ordinary skill in the art. Examples of such computer programming languages include C, C++, C#, Java, PHP, Python, Visual Basic, and the like, using any suitable software development platforms known to those of ordinary skill in the art.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available.

For example, certain process steps may be repeated and/or combined. More specifically, by way of example, when a customer checks in to a VIP Merchant hotel, the customer may be asked if they would like to join that VIP Merchant's VIP membership program. If the customer wishes to become a VIP member, the information normally provided at check-in may be used to populate that VIP Merchant's account. VIP membership program may immediately, or within a relatively short time frame such as five to ten minutes, send the new VIP member a confirmation message through email or text message asking them to reply, such as with their name, to confirm that the consumer desires to participate in the membership program. Doing so completes the registration process and the customers are now VIP members. The VIP member may also be prompted to provide their preferences.

Periodically, throughout their stay with the VIP Merchant hotel, the VIP members may receive a message presenting them with a list of perks, and asking them to choose one of a plurality of perks. For example, in one embodiment, an initial list may include dining, entertainment, nightlife, and shopping. When the VIP members make a selection, such as by replying with an indication of their selection, the VIP membership program may immediately, or within a relatively short time frame, reply with a discount or free item in that category. There is preferably no need to print a coupon. Rather, the VIP members merely present their mobile device at the venue. Subsequent lists may include those all or some of those categories from the initial list. For example, if the VIP member selected dining from the initial list, a subsequent list may only include entertainment, nightlife, and shopping.

The initial and subsequent lists may be predetermined based upon where the

VIP Merchant wants to drive traffic, that VIP member's buying history, that VIP member's preferences, that VIP member's geography, or some combination. For example, the initial list may include categories and/or items that the VIP Merchant has indicated a desire to push, that the VIP member has not previously purchased, but that the VIP member's preferences suggests they would like. Alternatively, the initial and subsequent lists may be completely or partially randomly generated. For example, subsequent lists may include predetermined categories not selected, as discussed above, but back filled by randomly determined categories.

These lists may also be mutli-layered. For example, if the VIP member selected dining from the initial list, they may be then presented with a list of restaurants from which to choose. When the VIP member replies with their selection, they are then sent the discount or free item from that restaurant that they may redeem by presenting their mobile device at the that restaurant.

These steps may also be extended across multiple visits. For example, subsequent lists, for subsequent visits, may be based on the initial list from a VIP member's first visit. More specifically, such lists may include categories not selected and/or perks not redeemed during the initial visit, and/or based on buying patterns established during the initial visit.

As discussed above, the messages sent to the VIP member may be personalized, beyond just using the VIP member's name. For example, the messages may be personalized to the VIP member's preferences, the VIP member's significant other's name, and/or some combination. More specifically, by way of example, a perk may comprise a buy one get one deal presented as “X's ‘drink/appetizer/entrée’ is free with your purchase of a ‘drink/appetizer/entrée’, where “X” is the VIP member's significant other's name and ‘drink/appetizer/entrée’ is selected from the VIP member's preferences and/or based upon buying patterns, etc. Such messages may include appointment or reservation information.

Additionally, rather than require VIP member's to provide their preferences upon becoming joining a program, the VIP member's preferences may be learned based on that VIP member's buying history. Similarly, a VIP member's preferences and/or qualifications to be a VIP member may be corrected and/or changed based on that VIP member's buying history. For example, if a VIP member indicates a preference for steaks, but never orders a steak and/or redeems perks for steaks, steaks may be removed from their preferences after a predetermined time and/or number of visits. Similarly, if a VIP member's buying history indicates that they no longer qualify, that VIP member may be enrolled in a lower-tier program, removed from the program, and/or encouraged to frequent the VIP merchant more often to remain in the program. Alternatively, if a VIP member's buying history indicates that they are an especially good patron, they may be automatically enrolled in a higher-tier program. A higher-tier program would preferably provide better perks and/or more frequent perks than a lower-tier program.

In any case, it can be seen that the present invention is much more than prior art coupon systems and/or prior art birthday clubs. For one thing, there is preferably no charge to the VIP Member, i.e. they are not expected to buy into a deal as in prior art coupon systems. Another difference is that Perks are preferably targeted, not just to VIP Members but to VIP Members that who have indicated a preference for that specific, type, or category of Perk, i.e. dinner, entertainment, a specific restaurant, a specific venue, a specific drink/appetizer/entrée, etc. The Perks may also be personalized beyond just a member's name and/or birthday. For example, the Perks may be personalized with combination deals with the VIP member's significant other and/or timed to coincide with a specific trip, not just an annual birthday event. Thus, it can be seen that the program of the present invention avoids the shotgun approach (where all members are offered the same perks and/or where members are offered a deal—typically the same deal—for their birthday). Rather, it can be seen that the program of the present invention actually creates conversations between VIP Members and VIP Merchants, much more so than blanket text email programs, thereby fostering longer term relationships between VIP Members and VIP Merchants.

It is also interesting to note that either, or both, sides of the conversation can be passive, i.e. by tracking how a specific VIP Member actually responds to the offers—which ones they choose to receive and which ones they actually redeem—the program provides the VIP Merchant with more useful information than any stock questionnaire. For example, the VIP Merchant can verify, or alter, the VIP member's true preferences. In this manner, the VIP Merchant may come to understand the VIP Members better than they understand themselves.

In one embodiment, a customer goes to the Web site and enters their mobile phone number and/or email address. The system then sends them a message, by text and/or email, asking the customer to reply with their first name, as confirmation that they wish to join the VIP program. Further messages may include login information to the Web site and/or Perks messages, as discussed above. Logging in to the Web site allows the VIP Member to add personal information such as their full name, their zip code, their significant other's name, both birthdays, etc. The Web site also allows the VIP Member to sign up with specific VIP Merchants and/or provide preferences, such as a favorite entrée at a VIP Merchant restaurant, etc.

The Web site may also track points in a rewards program. For example, VIP Members may receive points for signing up, for referring other customers who qualify for VIP Membership, and/or referring merchants who qualify and sign up to be VIP Merchants. Points may be redeemed for rewards, such as cash value at VIP Merchants, airfare and hotel paid trips to desirable locations, access to VIP Member parties near the VIP Member's location, VIP Member apparel and other merchandise and/or rewards.

The VIP program for the present invention may also be applied to other industries and/or services. For example, in addition to restaurant and hotel services, as discussed above, the VIP program may be applied to medical services for example. The perks messages may include recommendations for services and/or service reminders. More specifically, communication of promotional events, discounts, and other information may include communicating a prescription reminder that may include a discount on the prescription, a recommended pharmacy, and/or an indication of promotional events at a pharmacy. VIP program communication may also facilitate communication between the VIP merchant and the VIP member by assisting in coordinating appointments, reservations, scheduling services and the like.

In one specific embodiment, the VIP Members may actually be patients or clients of a healthcare community and/or other healthcare entities; including but not limited to medical doctors, veterinarians, physician assistants, nurse practitioners, pharmacists, physical therapists, occupational therapists, hospitals, sleep clinics, home health companies, nursing homes, assisted living facilities, hospice centers, durable and non-durable medical suppliers. In this case, the program of the present invention may include: enrolling at least one medical practice/healthcare professional to participate in the membership program; obtaining personal information from a patient; and contacting the patient to—obtain confirmation that the patient desires to participate in the membership program and communicate with the VIP Member Patient and/or their VIP Merchant physician and/or healthcare provider in a timely, simple fashion for any of a plurality of purposes. These purposes may include confirming an upcoming appointment for the patient; monitoring compliance with prescribed therapies; sending reminders to patients when they are due for prescription refills or blood work, etc.; coordinating pre-surgical and post-surgical logistics; coordinating inpatient stays and follow up; coordinating care between multiple specialists; coordinating imaging studies such as MRI's and CT's; coordinating the logistics of delivery of durable and non-durable medical supplies; coordinating home visits and hospice care; communicating sales, specials and discounts for various health care products and services; coordinating financial arrangements and bill pay; and/or sending educational and reference materials for the purpose of educating patient and clients about their disease processes.

According to certain aspects of the present inventions, the personal information obtained may include the patient's name, phone number and/or email address. The personal information may be collected while the patient is visiting the business, i.e. medical clinic, veterinary clinic, hospital, imaging center, pharmacy, physical therapy clinic, occupational therapy clinic, sleep center, home health company, nursing home, assisted living facility, hospice center, durable and non-durable medical suppliers, etc. Communications sent to the VIP Patient may be personalized, by using the patient's name, phone number and/or email address, and/or sent to the VIP Patient on the patient's mobile device and/or to their email address.

The VIP Program of the present invention may be implemented as a communication service that performs the steps of: enrolling at least one medical practice/healthcare professional to participate as VIP Merchants in the membership program; obtaining some personal information from a VIP Patient such as name, phone number and email address; contacting the VIP Patient via a remote device belonging to the patient to—obtain confirmation that the VIP Patient desires to participate in the VIP Program; and periodically providing information to the VIP Patient concerning a message from their VIP Merchant physician/healthcare provider.

What is claimed is:

1. A method of implementing a product and/or service promotion membership program, comprising the steps of:
a. enrolling at least one business to participate in the membership program;
b. obtaining personal information from a consumer;
c. contacting the consumer to:
i. obtain confirmation that the consumer desires to participate in the membership program; and
ii. obtain information about the consumer's interest in products or services provided by the participating business; and
d. periodically providing information to the consumer concerning a promotion available to the consumer at the participating business.

2. The method of claim 1, further comprising:
e. allowing the consumer to take advantage of the promotion without purchase a coupon.

3. The method of claim 2, further comprising:
f. allowing the consumer to take advantage of the promotion without employing the use of a membership card.

4. The method of claim 2, wherein the personal information obtained in step b is the consumer's phone number.

5. The method of claim 4, wherein as a part of step c, personal information about the consumer is obtained, including the consumer's name.

6. The method of claim 5, wherein as a further part of step c, the name of the consumer's significant other is obtained.

7. The method of claim 6, wherein when step d is performed, the information is personalized, by using the consumer's name.

8. The method of claim 7, wherein when step d is performed, the information is further personalized by using the significant other's name.

9. The method of claim 2, wherein step d is performed by sending a message to the consumer about the promotion on the consumer's remote device and further including the step of the consumer taking advantage of the promotion by showing the message on his or her remote device to an employee of the business.

10. The method of claim 1, wherein the personal information in step b is collected while the consumer is visiting the business.

11. A method of implementing a product and/or service promotion membership program, comprising the steps of:
a. enrolling at least one business to participate in the membership program;
b. obtaining some personal information from a consumer;
c. contacting the consumer via a remote device belonging to the consumer to:
i. obtain confirmation that the consumer desires to participate in the membership program; and
ii. obtain information about the consumer's interest in products or services provided by the participating business;
d. periodically providing information to the consumer concerning a promotion available to the consumer at the participating business, wherein the promotion is tailored to the consumer's interest; and
e. allowing the consumer to take advantage of the promotion without purchase a coupon.

12. The method of claim 11, further including the step of determining if the consumer takes advantage of the available promotion.

13. A method of implementing a product and/or service promotion membership program, comprising the steps of:
a. enrolling at least one business to participate in the membership program;
b. obtaining the telephone number or email address of a consumer while the consumer is visiting a business participating in the membership program;
c. contacting the consumer via a text message or email sent to the consumer's remote device to:
i. obtain confirmation that the consumer desires to participate in the membership program; and
ii. obtain personal information about the consumer;
d. periodically providing a message to the consumer via text or email concerning a promotion available to the consumer at the participating business; and
e. making the promotion available to the consumer by having the consumer show the message on his or her remote device to an employee at the business.

14. The method of claim 13, further including the step of tracking information about the consumer.

15. The method of claim 14, wherein the promotion is determined based on the information about the consumer.

16. The method of claim 14, wherein the information about the consumer includes the consumer's preferences and the promotion is determined based on the consumer's preferences.

17. The method of claim 14, wherein the information about the consumer includes the consumer's interests and the promotion is determined based on the consumer's interests.

18. The method of claim 14, wherein the information about the consumer includes the consumer's purchase history and the promotion is determined based on the consumer's purchase history.

19. The method of claim 13, wherein the promotion is determined based on the consumer's location.

20. The method of claim 13, wherein when step d is performed, the information is personalized, by using the information about the consumer.
